(19) United States
(12) Patent Application Publication
(10) Pub. No.: US 2025/0217180 A1
(43) Pub. Date: Jul. 3, 2025

(54) METHOD FOR CONTROLLING VIRTUAL MACHINE, ELECTRONIC DEVICE AND STORAGE MEDIUM

(71) Applicant: Beijing Baidu Netcom Science Technology Co., Ltd., Beijing (CN)

(72) Inventors: Kezhan Miao, Beijing (CN); Zhaoxin Li, Beijing (CN); Ru Ying, Beijing (CN); Ran Zheng, Beijing (CN); Xianjun Meng, Beijing (CN)

(21) Appl. No.: 19/083,981

(22) Filed: Mar. 19, 2025

(30) Foreign Application Priority Data
Dec. 20, 2024 (CN) 202411896540.2

(51) Int. Cl. G06F 9/455; G06F 11/30

(52) U.S. Cl. CPC G06F 9/45558; G06F 11/3034; G06F 2009/45562; G06F 2009/45575; G06F 2009/45595

(57) ABSTRACT

Provided is a method for controlling a virtual machine, an electronic device and a storage medium, relating to the field of computer technology, and in particular to application fields of cloud service, cloud computing and big data processing. The method includes: obtaining a virtual machine control request; generating a control operation instruction for a target virtual machine based on the virtual machine control request by using a computing node service deployed on the smart card; and sending the control operation instruction to a virtualization control program deployed on the physical machine; where the virtualization control program is used to perform a control operation on the target virtual machine based on the control operation instruction.

### CROSS-REFERENCE TO RELATED APPLICATIONS

The present application claims priority to Chinese Patent Application No. CN202411896540.2, filed with the China National Intellectual Property Administration on Dec. 20, 2024, the disclosure of which is hereby incorporated herein by reference in its entirety.

### TECHNICAL FIELD

The present disclosure relates to the field of computer technology, and in particular to application fields of cloud service, cloud computing and big data processing, and specifically to a method and an apparatus for controlling a virtual machine, an electronic device and a storage medium.

### BACKGROUND

With the development of computer technology, the virtual machine technology came into being to meet users' requirements for more efficient and flexible use of computing resources. This technology can create a plurality of virtual machines in a physical machine, and each virtual machine can independently run its own operating system and applications.

### SUMMARY

The present disclosure provides a method and an apparatus for controlling a virtual machine, an electronic device and a storage medium.

According to a first aspect of the present disclosure, provided is a method for controlling a virtual machine, applied to a smart card included in a system for controlling the virtual machine, where the system for controlling the virtual machine further includes a physical machine; and the method includes:
obtaining a virtual machine control request;
generating a control operation instruction for a target virtual machine based on the virtual machine control request by using a computing node service deployed on the smart card; and
sending the control operation instruction to a virtualization control program deployed on the physical machine; where the virtualization control program is used to perform a control operation on the target virtual machine based on the control operation instruction.

According to a second aspect of the present disclosure, provided is a method for controlling a virtual machine, applied to a physical machine included in a system for controlling the virtual machine, where the system for controlling the virtual machine further includes a smart card configured to obtain a virtual machine control request and generate a control operation instruction for a target virtual machine based on the virtual machine control request by using a computing node service deployed on the smart card; and the method includes:
receiving the control operation instruction; and
performing a control operation on the target virtual machine based on the control operation instruction.

According to a third aspect of the present disclosure, provided is an apparatus for controlling a virtual machine, applied to a smart card included in a system for controlling the virtual machine, where the system for controlling the virtual machine further includes a physical machine; and the apparatus includes:
a request obtaining unit configured to obtain a virtual machine control request;
an instruction generating unit configured to generate a control operation instruction for a target virtual machine based on the virtual machine control request by using a computing node service deployed on the smart card; and
an instruction sending unit configured to send the control operation instruction to a virtualization control program deployed on the physical machine; where the virtualization control program is used to perform a control operation on the target virtual machine based on the control operation instruction.

According to a fourth aspect of the present disclosure, provided is an apparatus for controlling a virtual machine, applied to a physical machine included in a system for controlling the virtual machine, where the system for controlling the virtual machine further includes a smart card configured to obtain a virtual machine control request and generate a control operation instruction for a target virtual machine based on the virtual machine control request by using a computing node service deployed on the smart card; and the apparatus includes:
an instruction receiving unit configured to receive the control operation instruction; and
a control operation unit configured to perform a control operation on the target virtual machine based on the control operation instruction.

According to a fifth aspect of the present disclosure, provided is an electronic device, including:
at least one processor;
a memory connected in communication with the at least one processor;
where the memory stores an instruction executable by the at least one processor, and the instruction, when executed by the at least one processor, enables the at least one processor to execute the method provided in the first aspect of the present disclosure.

According to a sixth aspect of the present disclosure, provided is a non-transitory computer-readable storage medium storing a computer instruction thereon, and the computer instruction is used to cause a computer to execute the method provided in the first aspect of the present disclosure.

According to a seventh aspect of the present disclosure, provided is a computer program product including a computer program, and the computer program implements the method provided in the first aspect of the present disclosure, when executed by a processor.

The present disclosure can greatly promote the rational use of resources of the physical machine, and avoid unnecessary waste of resources.

It should be understood that the content described in this part is not intended to identify critical or essential features of embodiments of the present disclosure, nor is it used to limit the scope of the present disclosure. Other features of the present disclosure will be easily understood through the following description.

### BRIEF DESCRIPTION OF THE DRAWINGS

The accompanying drawings are used to better understand the present solution, and do not constitute a limitation to the present disclosure.

FIG. 1 is a schematic diagram of resource occupation of a physical machine in the prior art;

FIG. 2 is a schematic flowchart of a method for controlling a virtual machine according to an embodiment of the present disclosure;

FIG. 3 is a schematic diagram of a device mounting process according to an embodiment of the present disclosure;

FIG. 4 is a schematic diagram of a device unmounting process according to an embodiment of the present disclosure;

FIG. 5 is a schematic diagram of a definition process of the target virtual machine according to an embodiment of the present disclosure;

FIG. 6 is a schematic diagram of a power-on process of the target virtual machine according to an embodiment of the present disclosure;

FIG. 7 is a schematic diagram of port allocation according to an embodiment of the present disclosure;

FIG. 8 is a schematic diagram of a power-off process of the target virtual machine according to an embodiment of the present disclosure;

FIG. 9 is a schematic diagram of a destruction process of the target virtual machine according to an embodiment of the present disclosure;

FIG. 10 is a schematic diagram of a deletion process of the target virtual machine according to an embodiment of the present disclosure;

FIG. 11 is a schematic diagram of an architecture for obtaining network disk monitoring data according to an embodiment of the present disclosure;

FIG. 12 is a schematic flowchart of a method for controlling a virtual machine according to an embodiment of the present disclosure;

FIG. 13 is a schematic diagram of an overall framework of a system for controlling a virtual machine according to an embodiment of the present disclosure;

FIG. 14 is a schematic diagram of a logical architecture of a system for controlling a virtual machine according to an embodiment of the present disclosure;

FIG. 15 is a schematic structural block diagram of an apparatus for controlling a virtual machine according to an embodiment of the present disclosure;

FIG. 16 is a schematic structural block diagram of an apparatus for controlling a virtual machine according to an embodiment of the present disclosure; and

FIG. 17 is a schematic structural block diagram of an electronic device according to an embodiment of the present disclosure.

### DETAILED DESCRIPTION

Hereinafter, descriptions to exemplary embodiments of the present disclosure are made with reference to the accompanying drawings, include various details of the embodiments of the present disclosure to facilitate understanding, and should be considered as merely exemplary. Therefore, those having ordinary skill in the art should realize, various changes and modifications may be made to the embodiments described herein, without departing from the scope of the present disclosure. Likewise, for clarity and conciseness, descriptions of well-known functions and structures are omitted in the following descriptions.

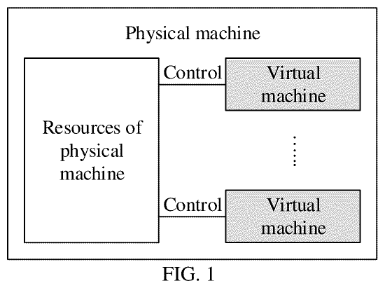

As shown in FIG. 1, in the prior art, before creating a plurality of virtual machines in a physical machine, it is usually necessary to reserve a large proportion (for example, more than 16%) of resources of the physical machine to bear virtualization overhead, resulting in a serious waste of resources of the physical machine. For example, to simulate N virtual machines with the specification of “the total number of cores of the physical machine being M/N”, at least two physical machines need to be prepared, and at least one of the two physical machines cannot be effectively utilized, thus resulting in a serious waste of resources of the physical machine.

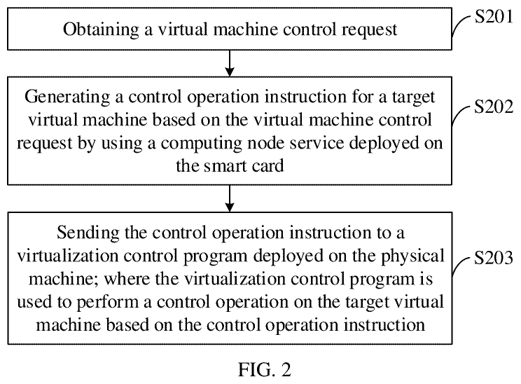

In view of the above problem, an embodiment of the present disclosure provides a method for controlling a virtual machine, and this method may be applied to a smart card included in a system for controlling the virtual machine. Here, the smart card may be a card-type device that integrates a microprocessor and a storage unit, and may also be understood as a device similar to a server. Moreover, in the embodiment of the present disclosure, the system for controlling the virtual machine further includes a physical machine. Here, the physical machine may be a server that is required to create a plurality of virtual machines. Hereinafter, the method for controlling the virtual machine provided in the embodiment of the present disclosure will be described in combination with the schematic flowchart shown in FIG. 2. It should be noted that a logical sequence is shown in the schematic flowchart, but the steps shown or described in the flowchart may also be performed in other sequences in some cases.

Step S201: obtaining a virtual machine control request.

Here, the virtual machine control request may be issued by a user to request a control operation to be performed on a target virtual machine.

Step S202: generating a control operation instruction for the target virtual machine based on the virtual machine control request by using a computing node service (Nova Compute) deployed on the smart card.

Here, the Nova Compute is a service component responsible for controlling virtual machines (for example, the target virtual machine). In one example, the Nova Compute may generate the control operation instruction for the target virtual machine based on the virtual machine control request. In one example, the Nova Compute may provide backend resources (for example, a network disk and/or a network port) for the target virtual machine based on the virtual machine control request, and generate the control operation instruction for the target virtual machine. Here, the control operation instruction may be a device mounting instruction and/or a device unmounting instruction for the target virtual machine, or may be any other operation instruction related to the life cycle of the target virtual machine, for example, at least one of a definition instruction, a power-on instruction, a power-off instruction, a destruction instruction or a deletion instruction.

Step S203: sending the control operation instruction to a virtualization control program (Libvirtd) deployed on the physical machine.

Here, the Libvirtd is a daemon process of a virtual machine manager (Libvirt), and is responsible for managing virtual machines (for example, the target virtual machine). Based on this, specifically in the embodiment of the present disclosure, the Libvirtd may be used to perform a control operation on the target virtual machine based on the control operation instruction.

Moreover, it should be noted that, in the embodiment of the present disclosure, the Libvirt may be a virtualization management toolkit, which may specifically provide an open source project with a virtual machine control tool.

The method for controlling the virtual machine provided in the embodiment of the present disclosure can obtain the virtual machine control request, generate the control operation instruction for the target virtual machine based on the virtual machine control request by using the Nova Compute deployed on the smart card, and then send the control operation instruction to the Libvirtd deployed on the physical machine, so as to use the Libvirtd to perform the control operation on the target virtual machine based on the control operation instruction. That is to say, in the embodiment of the present disclosure, one smart card independent of the physical machine is expanded. Based on the smart card, not only can a part of the control process for the target virtual machine be transplanted from the physical machine to the smart card, but the Nova Compute deployed on the smart card can also be used to provide backend resources for the target virtual machine, which can reduce the virtualization overhead that the physical machine needs to bear, and therefore can greatly promote the rational use of resources of the physical machine and avoid unnecessary waste of resources.

In one example, “generating a control operation instruction for the target virtual machine based on the virtual machine control request” in step S202 may include:
parsing the virtual machine control request to obtain control intention information for the target virtual machine; and
generating the control operation instruction for the target virtual machine based on the control intention information.

Here, the control intention represented by the control intention information may include at least one of:
mounting a virtual device on the target virtual machine, unmounting a virtual device from the target virtual machine, defining the target virtual machine, powering on the target virtual machine, powering off the target virtual machine, destroying the target virtual machine, or deleting the target virtual machine.

After obtaining the control intention information, the control operation instruction for the target virtual machine can be generated based on the control intention information. Here, the control operation instruction may include at least one of a device mounting instruction, a device unmounting instruction, a definition instruction, a power-on instruction, a power-off instruction, a destruction instruction or a deletion instruction. Here, the device mounting instruction is used to indicate mounting a virtual device on the target virtual machine; the device unmounting instruction is used to indicate unmounting a virtual device from the target virtual machine; the definition instruction is used to indicate defining the target virtual machine; the power-on instruction is used to indicate powering on the target virtual machine; the power-off instruction is used to indicate powering off the target virtual machine; the destruction instruction is used to indicate destroying the target virtual machine; and the deletion instruction is used to indicate deleting the target virtual machine.

Through the above manner, in the embodiment of the present disclosure, the virtual machine control request can be parsed to obtain the control intention information for the target virtual machine, and the control operation instruction for the target virtual machine can be generated based on the control intention information, so as to not only ensure that the control operation instruction is highly consistent with the control intention information, but also provide a solid foundation for the future expansion of the system for controlling the virtual machine and the adaptation to new requirements through the standardized control operation instruction. Moreover, in the embodiment of the present disclosure, since the control operation instruction may include at least one of the device mounting instruction, the device unmounting instruction, the definition instruction, the power-on instruction, the power-off instruction, the destruction instruction or the deletion instruction, the flexibility and practicality of the method for controlling the virtual machine can also be ensured.

In the following, the processes of generating the device mounting instruction, the device unmounting instruction, the definition instruction, the power-on instruction, the power-off instruction, the destruction instruction and the deletion instruction will be illustrated respectively.

### 1. Process of Generating the Device Mounting Instruction

(1) When the control intention represented by the control intention information is to mount a virtual device on the target virtual machine, selecting a first virtual device from a plurality of candidate virtual devices allocated to the target virtual machine.

The plurality of candidate virtual devices may include a plurality of virtual block devices (also known as Virtio Block VFs) and a plurality of virtual network devices. Here, the plurality of virtual network devices may include a plurality of auxiliary network cards (also known as Virtio Net VFs), and a plurality of primary network cards (also known as Rdma VFs) supporting the Remote Direct Memory Access (RDMA) function. It should be noted that, in the embodiment of the present disclosure, each candidate virtual device among the plurality of candidate virtual devices has its own identification information (for example, index number (also known as Index)). For example, there are N1 Virtio Block VFs among the plurality of candidate virtual devices, and the identification information of the N1 Virtio Block VFs may be: 0, 1, 2, 3, . . . , N1−1.

Moreover, it should be noted that, in the embodiment of the present disclosure, a candidate virtual device that matches the control intention information and is idle may be selected from the plurality of candidate virtual devices as the first virtual device after the plurality of candidate virtual devices allocated to the target virtual machine are determined. In one example, a list of unallocated index numbers may be determined from a total index bitmap associated with the plurality of candidate virtual devices, and an unallocated index number may be obtained from the list of index numbers. Then, when a candidate virtual device corresponding to the unallocated index number matches the control intention information, the candidate virtual device is used as the first virtual device. At this time, the “unallocated index number” corresponding to the first virtual device is the identification information of the first virtual device.

(2) Binding the first virtual device with a first backend resource.

Here, the first backend resource may be a Cloud Disk Service (CDS) provided by a Block Server, or may be a virtual network port created on the smart card, specifically a Quantum Virtual Port (QVO), and more specifically a QVO created on a network bridge device of the smart card. For easy distinction, the CDS here may be defined as the first network disk. Based on this, in the embodiment of the present disclosure, when the first virtual device is a Virtio Block VF, the first network disk may be used as the first backend resource and bound with the first virtual device; when the first virtual device is a Virtio Net VF or Rdma VF, the first network port may be used as the first backend resource and bound with the first virtual device.

(3) Generating the device mounting instruction carrying the control intention information and a first device identifier.

Here, the first device identifier is the identifier information of the first virtual device.

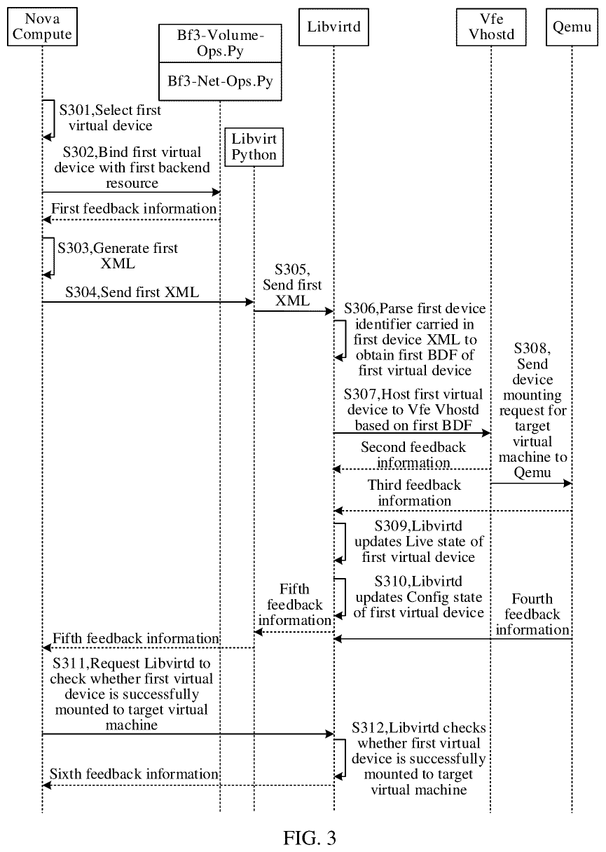

After the first virtual device is selected from the plurality of candidate virtual devices allocated to the target virtual machine and the first virtual device is bound with the first backend resource to generate the device mounting instruction carrying the control intention information and the first device identifier, the device mounting instruction can be sent to the Libvirtd deployed on the physical machine, to use the Libvirtd to mount the first virtual device on the target virtual machine based on the device mounting instruction. The process will be further described below in combination with FIG. 3.

Firstly, enter the preparation stage of the first virtual device:

Step S301: the Nova Compute selects the first virtual device from the plurality of candidate virtual devices allocated to the target virtual machine.

Step S302: the Nova Compute binds the first virtual device with the first backend resource.

In one example, when the first virtual device is a Virtio Block VF, the first network disk may be used as the first backend resource and bound with the first virtual device; when the first virtual device is a Virtio Net VF or Rdma VF, the first network port may be used as the first backend resource and bound with the first virtual device. Specifically, when the first virtual device is a Virtio Block VF, the first preset script (for example, Bf3-Volume-Ops.Py script) may be called to use the first network disk as the first backend resource and bind it with the first virtual device; when the first virtual device is a Virtio Net VF or Rdma VF, the second preset script (for example, Bf3-Net-Ops.Py script) may be called to use the first network port as the first backend resource and bind it with the first virtual device.

After the Nova Compute calls the first preset script and the second preset script to successfully bind the first virtual device with the first backend resource, the first preset script and the second preset script will send the first feedback information indicating that the first virtual device is successfully bound with the first backend resource to the Nova Compute.

After the binding succeeds, step S303 may be executed.

Step S303: the Nova Compute generates the device mounting instruction (also called first device XML) carrying the control intention information and the first device identifier.

As mentioned above, the first device identifier is the identification information of the first virtual device.

Then, enter the mounting stage of the first virtual device in the running (Live) state and configuration (Config) state:

Step S304: the Nova Compute sends the first device XML to a virtual machine development tool (Libvirt Python) deployed on the smart card.

Here, the Libvirt Python is an extension library of the programming language Python, and encapsulates calling methods of some Application Programming Interfaces (APIs) related to the Libvirtd. Therefore, the Libvirt Python can realize the interaction between the Nova Compute and Libvirtd more easily.

Step S305: the Libvirt Python sends the first device XML to the Libvirtd deployed on the physical machine.

In one example, the Libvirt Python may call the Libvirtd through a preset dynamic library (for example, Libvirt.so dynamic library) deployed on the smart card side, and transfer the first device XML to the Libvirtd.

Step S306: the Libvirtd parses the first device identifier carried in the first device XML to obtain the first device addressing information (Bus, Device, Function, BDF) of the first virtual device.

Step S307: the Libvirtd hosts the first virtual device to a virtual machine host (also called Vfe Vhostd) deployed on the physical machine based on the first BDF.

In one example, the Libvirtd may communicate through virtual machine control software (for example, Vfe Vhost Cli), and host the first virtual device to Vfe Vhostd deployed on the physical machine based on the first BDF.

Moreover, it can be understood that, in the embodiment of the present disclosure, after successfully hosting the first virtual device, the Vfe Vhostd will send the second feedback information indicating that the first virtual device has been successfully hosted to the Vfe Vhostd to the Libvirtd.

Step S308: the Libvirtd sends a device mounting request for the target virtual machine to a Quick Emulator (Qemu) deployed on the physical machine.

Here, the device mounting request is generated based on the first device XML; the Qemu may mount the first virtual device to the target virtual machine as a component of the target virtual machine in response to the device mounting request; the Qemu may send the third feedback information indicating that the device mounting request has been successfully received to the Libvirtd after receiving the device mounting request; and the Qemu may also send the fourth feedback information indicating that the first virtual device has been successfully mounted to the target virtual machine to the Libvirtd after successfully mounting the first virtual device to the target virtual machine in response to the device mounting request.

Moreover, it should be noted that, in the embodiment of the present disclosure, the Qemu can communicate with the Vfe Vhostd based on the first BDF after the Libvirtd sends the device mounting request for the target virtual machine to the Qemu.

Step S309: the Libvirtd updates the Live state of the first virtual device.

Here, the Live state of the first virtual device is the running state of the first virtual device.

Step S310: the Libvirtd updates the Config state of the first virtual device.

Here, the Config state of the first virtual device is the configuration state of the first virtual device.

After updating the Live state and the Config state of the first virtual device, the Libvirtd sends the fifth feedback information indicating that the first virtual device has been mounted to the Libvirt Python; and then the Libvirt Python sends the fifth feedback information to the Nova Compute.

Step S311: the Nova Compute requests the Libvirtd to check whether the first virtual device is successfully mounted to the target virtual machine.

Step S312: the Libvirtd checks whether the first virtual device is successfully mounted to the target virtual machine.

Here, the Libvirtd may check whether the first virtual device is successfully mounted to the target virtual machine by checking the Live state and the Config state of the first virtual device, and send the sixth feedback information carrying the check result to the Nova Compute.

In the above process, when the control intention represented by the control intention information is to mount a virtual device on the target virtual machine, the Nova Compute is used on the smart card side to select the first virtual device from the plurality of candidate virtual devices allocated to the target virtual machine, bind the first virtual device with the first backend resource, and then generate the device mounting instruction carrying the control intention information and the first device identifier. That is to say, when the virtual device is mounted on the target virtual machine, relatively more control processes for the target virtual machine will be completed on the smart card, and the Nova Compute will also be used to achieve the purpose of providing the backend resource (here, specifically the first backend resource, including the first network disk and/or the first network port) for the target virtual machine, thereby reducing the occupancy of resources of the physical machine. Therefore, the virtualization overhead that the physical machine needs to bear can be effectively reduced.

### 2. Process of Generating the Device Unmounting Instruction

When the control intention represented by the control intention information is to unmount a virtual device from the target virtual machine, the device unmounting instruction carrying the control intention information and a second device identifier is generated.

Here, the second device identifier is identification information of a second virtual device to be unmounted from the target virtual machine.

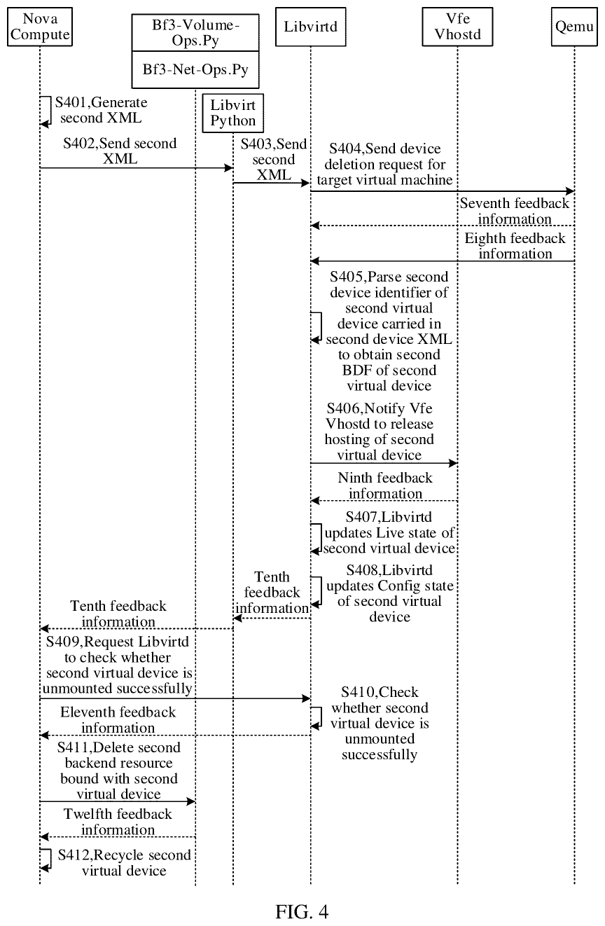

In one example, after the device unmounting instruction carrying the control intention information and the second device identifier is generated, the device unmounting instruction may be sent to the Libvirtd deployed on the physical machine, to unmount the second virtual device from the target virtual machine through the Libvirtd based on the device unmounting instruction. Thereafter, the Nova Compute may be used to generate a first recycling instruction for the target virtual machine, delete the second backend resource bound with the second virtual device based on the first recycling instruction to release the second virtual device, and then recycle the second virtual device. The process will be further described below in combination with FIG. 4.

Step S401: the Nova Compute generates the device unmounting instruction (also called second device XML) carrying the control intention information and the second device identifier.

As mentioned above, the second device identifier is the identification information of the second virtual device.

Step S402: the Nova Compute sends the second device XML to the Libvirt Python deployed on the smart card.

Step S403: the Libvirt Python sends the second device XML to the Libvirtd deployed on the physical machine.

Step S404: the Libvirtd sends a device deletion request for the target virtual machine to the Qemu deployed on the physical machine.

Here, the device deletion request is generated based on the second device XML; the Qemu may delete the second virtual device from the target virtual machine in response to the device deletion request; the Qemu may send the seventh feedback information indicating that the device deletion request has been successfully received to the Libvirtd after receiving the device deletion request; and the Qemu may also send the eighth feedback information indicating that the second virtual device has been successfully deleted from the target virtual machine to the Libvirtd after deleting the second virtual device from the target virtual machine in response to the device deletion request.

Step S405: the Libvirtd parses the second device identifier of the second virtual device carried in the second device XML to obtain the second BDF of the second virtual device.

Step S406: the Libvirtd notifies the Vfe Vhostd to release the hosting of the second virtual device based on the second BDF.

After successfully releasing the hosting of the second virtual device, the Vfe Vhostd will send the ninth feedback information indicating that the hosting of the second virtual device has been successfully released to the Libvirtd.

Step S407: the Libvirtd updates the Live state of the second virtual device.

Here, the Live state of the second virtual device is the running state of the second virtual device.

Step S408: the Libvirtd updates the Config state of the second virtual device.

Here, the Config state of the second virtual device is the configuration state of the second virtual device.

After updating the Live state and the Config state of the second virtual device, the Libvirtd sends the tenth feedback information indicating that the second virtual device has been unmounted to the Libvirt Python; and then the Libvirt Python sends the tenth feedback information to the Nova Compute.

Step S409: the Nova Compute requests the Libvirtd to check whether the second virtual device is unmounted successfully.

Step S410: the Libvirtd checks whether the second virtual device is unmounted successfully.

Here, the Libvirtd may check whether the second virtual device is successfully unmounted by checking the Live state and the Config state of the second virtual device, and send the eleventh feedback information carrying the check result to the Nova Compute.

Step S411: the Nova Compute generates a first recycling instruction for the target virtual machine, and deletes the second backend resource bound with the second virtual device based on the first recycling instruction.

In one example, when the second virtual device is a Virtio Block VF, the second backend resource bound with the second virtual device is a second network disk, so the second network disk bound with the second virtual device may be deleted; when the second virtual device is a Virtio Net VF or Rdma VF, the second backend resource bound with the second virtual device is a second network port, so the second network port bound with the second virtual device may be deleted. Specifically, when the second virtual device is a Virtio Blk VF, the third preset script (for example, Bf3-Volume-Ops.Py script) may be called to delete the second network disk bound with the second virtual device; when the second virtual device is a Virtio Net VF or Rdma VF, the fourth preset script (for example, Bf3-Net-Ops.Py script) may be called to delete the second network port bound with the second virtual device.

After the Nova Compute calls the third preset script and the fourth preset script to delete the second network port bound with the second virtual device, the third preset script and the fourth preset script will send the twelfth feedback information indicating that the first virtual device is successfully bound with the first backend resource to the Nova Compute.

Step S412: recycle the second virtual device.

For example, the second virtual device may be used as an idle candidate virtual device corresponding to the target virtual machine, that is, the second device identifier is put into a list of unallocated index numbers related to the target virtual machine, to implement recycling of the second device identifier.

In the above process, when the control intention represented by the control intention information is to unmount a virtual device from the target virtual machine, the device unmounting instruction carrying the control intention information and the second device identifier is generated, that is, a part of the control process for the target virtual machine can be transplanted from the physical machine to the smart card, thereby effectively reducing the virtualization overhead that the physical machine needs to bear; and, after the device unmounting instruction is sent to the Libvirtd deployed on the physical machine to unmount the second virtual device from the target virtual machine through the Libvirtd based on the device unmounting instruction, the Nova Compute may be used to generate the first recycling instruction for the target virtual machine, and delete the second backend resource bound with the second virtual device based on the first recycling instruction, to release the second virtual device. In this way, the effective utilization of the virtual device can be achieved by recycling the second virtual device.

### 3. Process of Generating the Definition Instruction

(1) When the control intention represented by the control intention information is to define the target virtual machine, allocating a plurality of candidate virtual devices to the target virtual machine.

In one example, a plurality of candidate virtual devices may be allocated to the target virtual machine according to the specification of the target virtual machine.

(2) Using a plurality of identification information and configuration information of the target virtual machine together as overall description information of the target virtual machine.

Here, the plurality of identification information corresponds to the plurality of candidate virtual machines one by one; and the configuration information of the target virtual machine may include chipset type, Peripheral Component Interconnect (PCI) bus architecture, device form information (for example, form information of system disk/primary network card, graphics card, serial port, memory (Ballon), keyboard and mouse, and clock device), firmware information (for example, Basic Input Output System (BIOS) information, motherboard information), system information, etc.

(3) Generating the definition instruction carrying the control intention information and the overall description information.

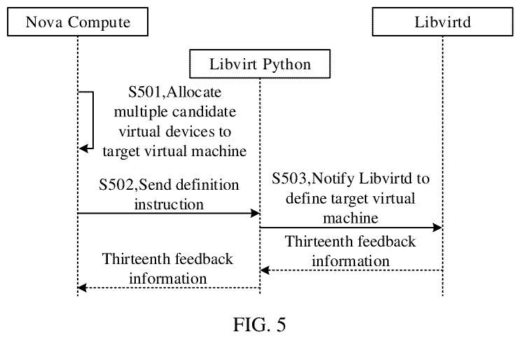

In one example, after the definition instruction carrying the control intention information and the overall description information is generated, the definition instruction may be sent to the Libvirtd deployed on the physical machine, to define the target virtual machine through the Libvirtd based on the definition instruction. The process will be further described below in combination with FIG. 5.

Step S501: the Nova Compute allocates a plurality of candidate virtual devices to the target virtual machine.

Step S502: the Nova Compute sends a definition instruction to the Libvirt Python deployed on the smart card.

Here, the definition instruction may carry the control intention information and overall description information. Here, the overall description information may include a plurality of indexes and the configuration information of the target virtual machine, and the plurality of identification information corresponds to the plurality of candidate virtual devices one by one.

Step S503: the Libvirt Python notifies the Libvirtd to define the target virtual machine.

In one example, the Libvirt Python may call a first preset interface (e.g., LibvirtPython define XML interface) to notify the Libvirtd to define the target virtual machine.

After the Libvirt Python notifies the Libvirtd to define the target virtual machine, the Libvirtd enters the process of defining the target virtual machine and sends the thirteenth feedback information indicating that the definition of the target virtual machine has been completed to the Libvirt Python, and the Libvirt Python then sends the thirteenth feedback information to the Nova Compute.

In the above process, when the control intention represented by the control intention information is to define the target virtual machine, the plurality of candidate virtual devices are allocated to the target virtual machine, the plurality of indexes and the configuration information of the target virtual machine are used together as the overall description information of the target virtual machine, and then the definition instruction carrying the control intention information and the overall description information is generated. That is to say, when the target virtual machine is defined, relatively more control processes are completed on the smart card, so the virtualization overhead that the physical machine needs to bear can be further reduced.

### 4. Process of Generating the Power-On Instruction

(1) When the control intention represented by the control intention information is to power on the target virtual machine, selecting a third virtual device from a plurality of candidate virtual devices allocated to the target virtual machine.

Here, the plurality of candidate virtual devices may include a plurality of Virtio Block VFs and a plurality of virtual network devices. Here, the plurality of virtual network devices may include a plurality of Virtio Net VFs, and a plurality of Rdma VFs supporting the RDMA function. It should be noted that, in the embodiment of the present disclosure, each candidate virtual device among the plurality of candidate virtual devices has its own identification information. For example, there are N1 Virtio Block VFs among the plurality of candidate virtual devices, and the identification information of the N1 Virtio Block VFs may be: 0, 1, 2, 3, . . . , N1−1.

Moreover, it should be noted that, in the embodiment of the present disclosure, a candidate virtual device that matches the control intention information and is idle may be selected from the plurality of candidate virtual devices as the third virtual device after the plurality of candidate virtual devices allocated to the target virtual machine are determined. In one example, a list of unallocated index numbers may be determined from a total index bitmap associated with the plurality of candidate virtual devices, and an unallocated index number may be selected from the list of index numbers. Then, when a candidate virtual device corresponding to the unallocated index number matches the control intention information, the candidate virtual device is used as the third virtual device. At this time, the “unallocated index number” corresponding to the third virtual device is the identification information of the third virtual device.

(2) Binding the third virtual device with a third backend resource.

Here, the third backend resource may be a CDS provided by a Block Server, or may be a virtual network port created on the smart card, specifically a QVO, and more specifically a QVO created on a network bridge device of the smart card. For easy distinction, the CDS here may be defined as the third network disk. Based on this, in the embodiment of the present disclosure, when the third virtual device is a Virtio Block VF, the third network disk may be used as the third backend resource and bound with the third virtual device; when the third virtual device is a Virtio Net VF or Rdma VF, the third network port may be used as the third backend resource and bound with the third virtual device.

(3) Sending a redefinition instruction carrying the control intention information and overall description information to the Libvirtd.

Here, the overall description information includes a plurality of identification information corresponding to the plurality of candidate virtual devices one by one, and the configuration information of the target virtual machine.

(4) When receiving redefinition feedback information returned by the Libvirtd, generating the power-on instruction carrying the control intention information and a third device identifier.

As mentioned above, the third device identifier is the identification information of the third virtual device.

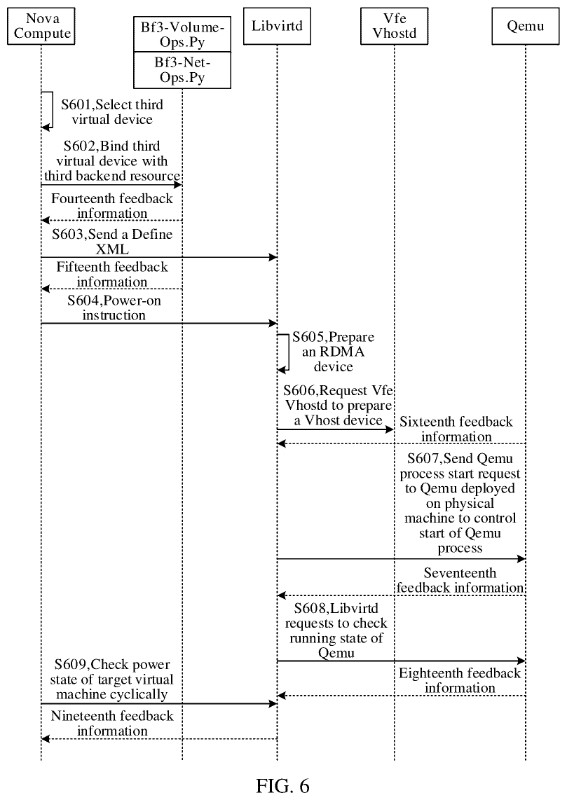

After selecting the third virtual device from the plurality of candidate virtual devices allocated to the target virtual machine, binding the third virtual device with the third backend resource, sending the redefinition instruction carrying the control intention information and the overall description information to the Libvirtd, then receiving the redefinition feedback information returned by the Libvirtd and generating the power-on instruction carrying the control intention information and the third device identifier, the power-on instruction can be sent to the Libvirtd deployed on the physical machine, to power on the target virtual machine through the Libvirtd. The process will be further described below in combination with FIG. 6.

Step S601: the Nova Compute selects the third virtual device from the plurality of candidate virtual devices allocated to the target virtual machine.

Step S602: the Nova Compute binds the third virtual device with the third backend resource.

In one example, when the third virtual device is a Virtio Block VF, the third network disk may be used as the third backend resource and bound with the third virtual device; when the third virtual device is a Virtio Net VF or Rdma VF, the third network port may be used as the third backend resource and bound with the third virtual device. Specifically, when the third virtual device is a Virtio Block VF, the fifth preset script (for example, Bf3-Volume-Ops.Py script) may be called to use the third network disk as the third backend resource and bind it with the third virtual device; when the third virtual device is a Virtio Net VF or Rdma VF, the sixth preset script (for example, Bf3-Net-Ops.py script) may be called to use the third network port as the third backend resource and bind it with the third virtual device.

After the Nova Compute calls the fifth preset script and the sixth preset script to successfully bind the third virtual device with the third backend resource, the fifth preset script and the sixth preset script will send the fourteenth feedback information indicating that the third virtual device is successfully bound with the third backend resource to the Nova Compute.

After the binding succeeds, step S603 may be executed.

Step S603: the Nova Compute sends a redefinition instruction (also called Define XML) carrying the control intention information and the overall description information to the Libvirtd.

Here, the overall description information includes a plurality of identification information corresponding to the plurality of candidate virtual devices one by one, and the configuration information of the target virtual machine.

Moreover, in the embodiment of the present disclosure, after receiving the Define XML, the Libvirtd will send the fifteenth feedback information indicating that the Define XML has been successfully received to the Nova Compute.

Step S604: the Nova Compute generates the power-on instruction carrying the control intention information and the third device identifier.

As mentioned above, the third device identifier is the identification information of the third virtual device.

In one example, the Nova Compute may call a second preset interface (e.g., LibvirtPython define XML interface) to redefine the domain information of the target virtual machine, and call a third preset interface (e.g., CreateWithFlags interface) to send a power-on request to the Libvirtd, that is, generate the power-on instruction carrying the control intention information and the third device identifier and send it to the Libvirtd.

Step S605: the Libvirtd prepares an RDMA device.

When the third virtual device is an Rdma VF, the RDMA device may be obtained based on the third virtual device bound with the third network port; when the third virtual device is not an Rdma VF, a virtual device may be reselected from the plurality of candidate virtual devices to obtain the RDMA device, which will not be described in detail here.

Step S606: the Libvirtd requests the Vfe Vhostd deployed on the physical machine to prepare a Vhost device.

Here, the preparation of the Vhost device may be to host the third virtual device to the Vhost device.

Moreover, in the embodiment of the present disclosure, after preparing the Vhost device, the Vfe Vhostd will send the sixteenth feedback information to the Libvirtd to indicate that the preparation of the Vhost device has been completed.

Step S607: the Libvirtd sends a Qemu process start request to the Qemu deployed on the physical machine to control the start of the Qemu process.

After the Qemu process is started, the Qemu can communicate with the Vfe Vhostd.

Moreover, in the embodiment of the present disclosure, after the Qemu process is started, the seventeenth feedback information will be sent to the Libvirtd to indicate that the Qemu process has been started.

Step S608: the Libvirtd requests to check the running state of the Qemu.

Here, the Libvirtd may also receive the eighteenth feedback information sent by the Qemu to the Nova Compute to indicate the state detection result of the Qemu (for example, Power State: Runninglpgopause).

Step S609: the Nova Compute sends a power state detection request for the target virtual machine cyclically to the Libvirtd.

After sending the power state detection request for the target virtual machine to the Libvirtd, the Nova Compute will receive the nineteenth feedback information sent by the Libvirtd to indicate the power state of the target virtual machine.

In the above process, when the control intention represented by the control intention information is to power on the target virtual machine, the third virtual device is selected from the plurality of candidate virtual devices allocated to the target virtual machine and is bound with the third backend resource, and then the redefinition instruction carrying the control intention information and the overall description information is sent to the Libvirtd, so as to generate the power-on instruction carrying the control intention information and the third device identifier when receiving the redefinition feedback information returned by the Libvirtd. That is to say, when the target virtual machine is powered on, relatively more control processes for the target virtual machine will be completed on the smart card, and the Nova Compute will also be used to achieve the purpose of providing the backend resource (here, specifically the third backend resource, including the third network disk and/or the third network port) for the target virtual machine, thereby reducing the occupancy of resources of the physical machine. Therefore, the virtualization overhead that the physical machine needs to bear can be effectively reduced.

Moreover, it should be noted that, in the embodiment of the present disclosure, when the power-on instruction carrying the control intention information and the third device identifier is generated, specifically the power-on instruction carrying the control intention information, the third device identifier and the port range data of the smart card may be generated, so that the port range data of the smart card can be sent to the Libvirtd to ensure that the target virtual machine can communicate with the external network normally and stably.

Relatedly, an embodiment of the present disclosure further provides a second manner to send the port range data of the smart card to the Libvirtd. Specifically, multi-port range mapping (also known as Iptbales port mapping) may be used to create Source Network Address Translation (SNAT) and Destination Network Address Translation (DNAT) rules, to thereby implement the allocation of the Virtual Network Computing (VNC) port.

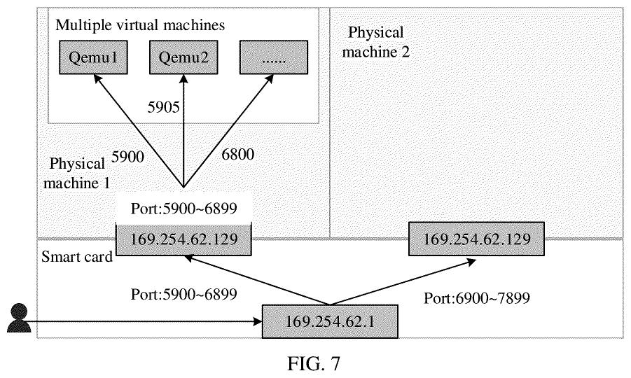

Referring to FIG. 7, exemplarily, when an external network wants to access any virtual machine created on the physical machine, the external network may firstly enter through an entry address (i.e., 169.254.62.1), and the network traffic accessing the VNC may be routed to an intermediate address (i.e., 169.254.62.129) based on the target port number (e.g., a port in the port range of 5900 to 6899) according to the DNAT rule, and then further routed to a corresponding Qemu virtual machine through a specific port. On the contrary, when a Qemu virtual machine needs to communicate with the external network, the Qemu virtual machine may send the VNC traffic to an external address through the entry address according to the SNAT rule.

The allocation process of the VNC port will be described below:

The Nova Compute calls a sixth preset interface (e.g., CreateWithFlags of Libvirt Python interface) to start the target virtual machine.

The Libvirt Python calls a seventh preset interface (e.g., VirDomainCreateSetMetadata interface) (in the Remote Driver) to mount the port range data (i.e., port range metadata) of the smart card into the Live state of the target virtual machine.

The Libvirtd obtains the port range data of the smart card from the target virtual machine and allocates the VNC port therein.

### 5. Process of Generating the Power-Off Instruction

When the control intention represented by the control intention information is to power off the target virtual machine, the power-off instruction carrying the control intention information is generated.

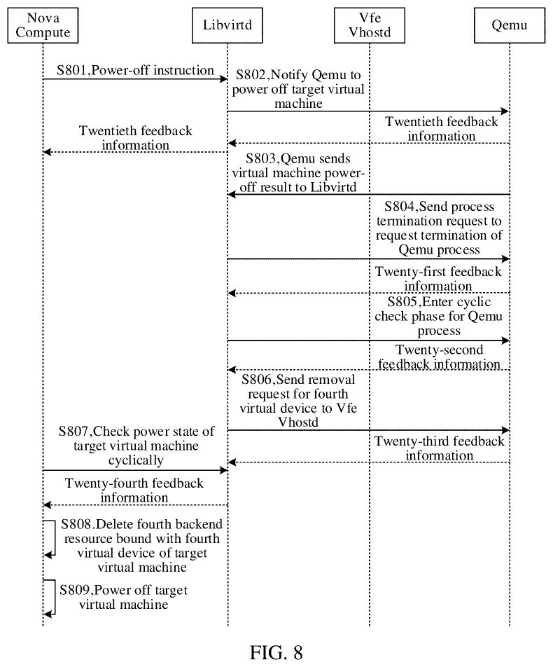

After the power-off instruction carrying the control intention information is generated, the power-off instruction can be sent to the Libvirtd deployed on the physical machine, to power off the target virtual machine through the Libvirtd based on the power-off instruction. Thereafter, the Nova Compute is used to generate a second recycling instruction for the target virtual machine, and delete the fourth backend resource bound with a fourth virtual device of the target virtual machine based on the second recycling instruction, to release the fourth virtual device. The process will be further described below in combination with FIG. 8.

Step S801: the Nova Compute generates the power-off instruction carrying the control intention information, and sends the power-off instruction to the Libvirtd.

In one example, the Nova Compute may generate the power-off instruction carrying the control intention information, and send the power-off instruction to the Libvirtd deployed on the physical machine through a fourth preset interface (e.g., LibvirtPython Shudown interface).

Step S802: the Libvirtd notifies the Qemu to power off the target virtual machine after receiving the power-off instruction.

Here, the Libvirtd may notify the Qemu to power off the target virtual machine through the QEMU Machine Protocol (QPM), and the Qemu may send an Advanced Configuration and Power Interface (ACPI) interrupt message to a specific software entity (such as Guest) running in the target virtual machine, or pull up the pin of the simulated General-Purpose Input/Output (GPIO) interface, to notify the operating system of the target virtual machine to shut down.

After receiving the power-off prompt sent by the Libvirtd, the Qemu may send the twenty-first feedback information to the Libvirtd, and then the Libvirtd may send the twentieth feedback information to the Nova Compute to indicate that the power-off instruction has been received.

Step S803: the Qemu sends a virtual machine power-off result to the Libvirtd.

Step S804: the Libvirtd sends a process termination request to the Qemu to request the termination of the Qemu process.

In one example, the Libvirtd may firstly send a Kill-15 instruction to the Qemu to request the termination of the Qemu process.

After receiving the process termination request sent by the Libvirtd, the Qemu may send the twenty-first feedback information to the Libvirtd to indicate whether the Qemu process has been terminated.

Step S805: enter the cyclic check phase for the Qemu process.

Specifically, the Libvirtd sends the process termination request to the Qemu multiple times, to request the termination of the Qemu process. In one example, the Libvirtd may firstly send a Kill-15 instruction to the Qemu to request the termination of the Qemu process; and the Qemu may attempt to terminate the Qemu process after receiving the Kill-15 instruction, and send the twenty-second feedback information to the Libvirtd to indicate whether the Qemu process is successfully terminated. If the Qemu process is not successfully terminated, the Libvirtd may send a Kill-9 instruction to the Qemu to request the forced termination of the Qemu process.

Step S806: the Libvirtd sends a removal request for the fourth virtual device to the Vfe Vhostd.

After receiving the removal request for the fourth virtual device, the Vfe Vhostd removes the fourth virtual device and sends the twenty-third feedback information to the Libvirtd to indicate that the fourth virtual device has been removed.

Step S807: the Nova Compute sends a power state detection request for the target virtual machine cyclically to the Libvirtd.

After sending the power state detection request for the target virtual machine to the Libvirtd, the Nova Compute will receive the twenty-fourth feedback information sent by the Libvirtd to indicate the power state of the target virtual machine.

Step S808: the Nova Compute generates a second recycling instruction for the target virtual machine, and deletes the fourth backend resource bound with the fourth virtual device of the target virtual machine based on the second recycling instruction to release the fourth virtual device.

In one example, when the fourth virtual device is a Virtio Block VF, the fourth backend resource bound with the fourth virtual device is a fourth network disk, so the fourth network disk bound with the fourth virtual device may be deleted; when the fourth virtual device is a Virtio Net VF or Rdma VF, the fourth backend resource bound with the fourth virtual device is a fourth network port, so the fourth network port bound with the fourth virtual device may be deleted. Specifically, when the fourth virtual device is a Virtio Blk VF, the seventh preset script (for example, Bf3-Volume-Ops.Py script) may be called to delete the fourth network disk bound with the fourth virtual device; when the fourth virtual device is a Virtio Net VF or Rdma VF, the eighth preset script (for example, Bf3-Net-Ops.Py script) may be called to delete the fourth network port bound with the fourth virtual device.

Step S809: power off the target virtual machine.

In the above process, when the control intention represented by the control intention information is to power off the target virtual machine, the power-off instruction carrying the control intention information is generated, and the power-off instruction is sent to the Libvirtd deployed on the physical machine after the power-off instruction carrying the control intention information is generated, to power off the target virtual machine through the Libvirtd based on the power-off instruction. Thereafter, the Nova Compute is used to generate the second recycling instruction for the target virtual machine, and delete the fourth backend resource bound with the fourth virtual device of the target virtual machine based on the second recycling instruction to release the fourth virtual device. That is to say, when the target virtual machine is powered off, relatively more control processes for the target virtual machine will be completed on the smart card, thereby reducing the virtualization overhead that the physical machine needs to bear.

### 6. Process of Generating the Destruction Instruction

When the control intention represented by the control intention information is to destroy the target virtual machine, the destruction instruction carrying the control intention information is generated.

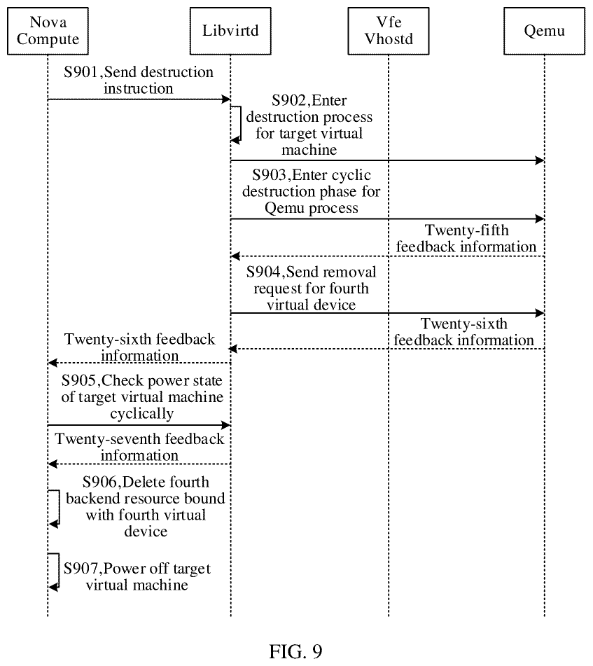

After the destruction instruction carrying the control intention information is generated, the destruction instruction can be sent to the Libvirtd deployed on the physical machine, to destroy the target virtual machine through the Libvirtd based on the destruction instruction. Thereafter, the Nova Compute is used to generate a second recycling instruction for the target virtual machine, and delete the fourth backend resource bound with a fourth virtual device of the target virtual machine based on the second recycling instruction, to release the fourth virtual device. The process will be further described below in combination with FIG. 9.

Step S901: the Nova Compute generates the destruction instruction carrying the control intention information, and sends the destruction instruction to the Libvirtd.

Step S902: the Libvirtd enters the destruction process for the target virtual machine after receiving the destruction instruction.

Step S903: enter the cyclic destruction phase for the Qemu process.

Specifically, the Libvirtd sends the process destruction request to the Qemu multiple times, to request the destruction of the Qemu process. In one example, the Libvirtd may firstly send a Kill-15 instruction to the Qemu to request the destruction of the Qemu process; and the Qemu may attempt to destroy the Qemu process after receiving the Kill-15 instruction, and send the twenty-fifth feedback information to the Libvirtd to indicate whether the Qemu process is successfully destroyed. If the Qemu process is not successfully destroyed, the Libvirtd may send a Kill-9 instruction to the Qemu to request the forced destruction of the Qemu process.

Step S904: the Libvirtd sends a removal request for the fourth virtual device to the Vfe Vhostd.

After removing the fourth virtual device, the Vfe Vhostd may send the feedback information of successful removal to the Libvirtd.

After receiving the removal request for the fourth virtual device, the Vfe Vhostd removes the fourth virtual device and sends the twenty-sixth feedback information to the Libvirtd. Then, the Libvirtd sends the twenty-sixth feedback information to the Nova Compute to indicate that the fourth virtual device has been removed.

Step S905: the Nova Compute sends a power state detection request for the target virtual machine cyclically to the Libvirtd.

After sending the power state detection request for the target virtual machine to the Libvirtd, the Nova Compute will receive the twenty-seventh feedback information sent by the Libvirtd to indicate the power state of the target virtual machine.

Step S906: the Nova Compute generates a second recycling instruction for the target virtual machine, and deletes the fourth backend resource bound with the fourth virtual device of the target virtual machine based on the second recycling instruction to release the fourth virtual device.

In one example, when the fourth virtual device is a Virtio Block VF, the fourth backend resource bound with the fourth virtual device is a fourth network disk, so the fourth network disk bound with the fourth virtual device may be deleted; when the fourth virtual device is a Virtio Net VF or Rdma VF, the fourth backend resource bound with the fourth virtual device is a fourth network port, so the fourth network port bound with the fourth virtual device may be deleted. Specifically, when the fourth virtual device is a Virtio Blk VF, the seventh preset script (for example, Bf3-Volume-Ops.Py script) may be called to delete the fourth network disk bound with the fourth virtual device; when the fourth virtual device is a Virtio Net VF or Rdma VF, the eighth preset script (for example, Bf3-Net-Ops.Py script) may be called to delete the fourth network port bound with the fourth virtual device.

Step S907: power off the target virtual machine.

In the above process, when the control intention represented by the control intention information is to destroy the target virtual machine, the destruction instruction carrying the control intention information is generated, and the destruction instruction is sent to the Libvirtd deployed on the physical machine after the destruction instruction carrying the control intention information is generated, to destroy the target virtual machine through the Libvirtd based on the destruction instruction. Thereafter, the Nova Compute is used to generate the second recycling instruction for the target virtual machine, and delete the fourth backend resource bound with the fourth virtual device of the target virtual machine based on the second recycling instruction to release the fourth virtual device. That is to say, when the target virtual machine is destroyed, relatively more control processes for the target virtual machine will be completed on the smart card, thereby reducing the virtualization overhead that the physical machine needs to bear.

### 7. Process of Generating the Deletion Instruction

When the control intention represented by the control intention information is to delete the target virtual machine, the deletion instruction carrying the control intention information is generated.

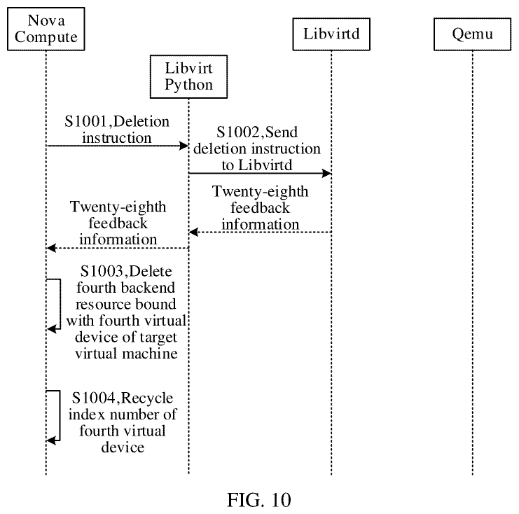

After the deletion instruction carrying the control intention information is generated, the deletion instruction can be sent to the Libvirtd deployed on the physical machine, to delete the target virtual machine through the Libvirtd based on the deletion instruction. Thereafter, the Nova Compute is used to generate a second recycling instruction for the target virtual machine, and delete the fourth backend resource bound with a fourth virtual device of the target virtual machine based on the second recycling instruction, to release the fourth virtual device. The process will be further described below in combination with FIG. 10.

Step S1001: the Nova Compute generates the deletion instruction carrying the control intention information, and sends the deletion instruction to the Libvirt Python.

In one example, after generating the deletion instruction carrying the control intention information, the Nova Compute may call a fifth preset interface (e.g., Libvirt Python undefine interface) to send the deletion instruction to the Libvirt Python.

Step S1002: the Libvirt Python sends the deletion instruction to the Libvirtd.

Here, the Libvirtd is used to remove the Domain information of the target virtual machine after receiving the deletion instruction.

After receiving a removal request for the fourth virtual device, the Vfe Vhostd removes the fourth virtual device and sends the twenty-eighth feedback information to the Libvirtd. Then, the Libvirtd sends the twenty-eighth feedback information to the Nova Compute to indicate that the fourth virtual device has been removed.

Step S1003: the Nova Compute generates a second recycling instruction for the target virtual machine, and deletes the fourth backend resource bound with the fourth virtual device of the target virtual machine based on the second recycling instruction to release the fourth virtual device.

In one example, when the fourth virtual device is a Virtio Block VF, the fourth backend resource bound with the fourth virtual device is a fourth network disk, so the fourth network disk bound with the fourth virtual device may be deleted; when the fourth virtual device is a Virtio Net VF or Rdma VF, the fourth backend resource bound with the fourth virtual device is a fourth network port, so the fourth network port bound with the fourth virtual device may be deleted. Specifically, when the fourth virtual device is a Virtio Blk VF, the seventh preset script (for example, Bf3-Volume-Ops.Py script) may be called to delete the fourth network disk bound with the fourth virtual device; when the fourth virtual device is a Virtio Net VF or Rdma VF, the eighth preset script (for example, Bf3-Net-Ops.Py script) may be called to delete the fourth network port bound with the fourth virtual device.

Step S1004: recycle the index number of the fourth virtual device.

In the above process, when the control intention represented by the control intention information is to delete the target virtual machine, the deletion instruction carrying the control intention information is generated, and the deletion instruction is sent to the Libvirtd deployed on the physical machine after the deletion instruction carrying the control intention information is generated, to delete the target virtual machine through the Libvirtd based on the deletion instruction. Thereafter, the Nova Compute is used to generate the second recycling instruction for the target virtual machine, and delete the fourth backend resource bound with the fourth virtual device of the target virtual machine based on the second recycling instruction to release the fourth virtual device. During this process, a large part of the control process is completed on the smart card, thus further reducing the virtualization overhead that the physical machine needs to bear.

In some optional implementations, the method for controlling the virtual machine may further include:
obtaining network disk monitoring data of the target virtual machine by using a virtualization monitoring component (Libvirt Monitor) deployed on the smart card; and
sending the network disk monitoring data to a cloud management server.

Here, the network disk monitoring data may be stored in the monitoring log.

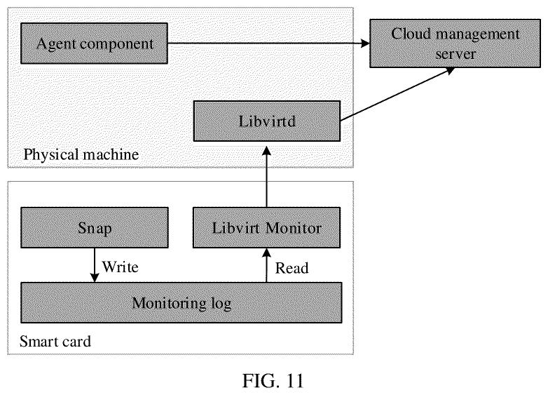

Referring to FIG. 11, the network disk monitoring data of the target virtual machine may be obtained by monitoring the target virtual machine through the snapshot function component (Snap), and written into the monitoring log for storage; and then the Libvirt Monitor reads the network disk monitoring data of the target virtual machine from the monitoring log and sends it to the cloud management server.

Here, the Libvirt Monitor also communicates with the Libvirtd deployed on the physical machine, while the Libvirtd also communicates with an agent component deployed on the physical machine. Here, the agent component can also obtain the health data of some target virtual machines and send it to the cloud management server.

Through the above method, in the embodiment of the present disclosure, the virtualization monitoring component deployed on the smart card can be used to obtain the network disk monitoring data of the target virtual machine and send the network disk monitoring data to the cloud management server, realizing data monitoring of the target virtual machine, and ensuring the security of the system for controlling the virtual machine.

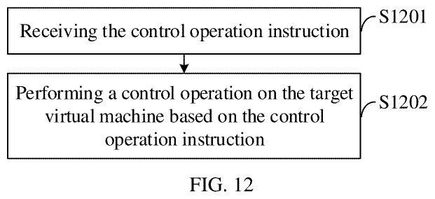

An embodiment of the present disclosure provides a method for controlling a virtual machine, and this method may be applied to a physical machine included in the system for controlling the virtual machine. Here, the physical machine may be a server that is required to create a plurality of virtual machines. Moreover, in the embodiment of the present disclosure, the system for controlling the virtual machine further includes a smart card configured to obtain a virtual machine control request and generate a control operation instruction for a target virtual machine based on the virtual machine control request by using a computing node service deployed on the smart card. Here, the smart card may be a card-type device that integrates a microprocessor and a storage unit, and may also be understood as a device similar to a server. Hereinafter, the method for controlling the virtual machine provided in the embodiment of the present disclosure will be described in combination with the schematic flowchart shown in FIG. 12. It should be noted that a logical sequence is shown in the schematic flowchart, but the steps shown or described in the flowchart may also be performed in other sequences in some cases.

Step S1201: receiving the control operation instruction.

Step S1202: performing a control operation on the target virtual machine based on the control operation instruction.

Here, the control operation instruction includes at least one of a device mounting instruction, a device unmounting instruction, a definition instruction, a power-on instruction, a power-off instruction, a destruction instruction or a deletion instruction.

In the embodiment of the present disclosure, the specific functions and examples of the units in the method for controlling the virtual machine can refer to the relevant description of the corresponding steps in the above-mentioned embodiments of the method for controlling the virtual machine, and will not be repeated here.

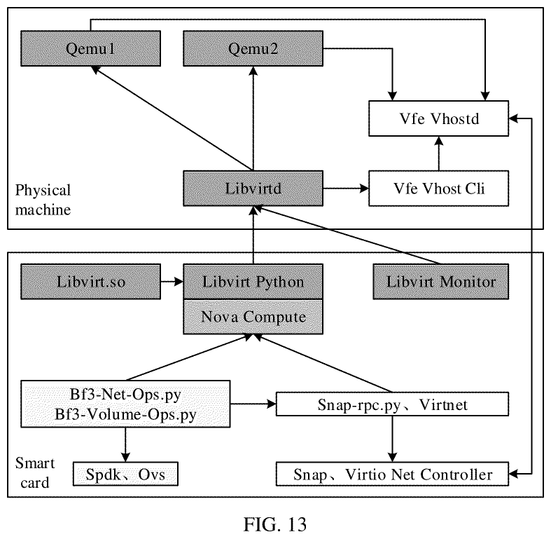

Referring to FIG. 13, FIG. 13 shows a system for controlling a virtual machine according to an embodiment of the present disclosure, including a physical machine and a smart card.

Here, deployed on the smart card are:
(1) Nova Compute, which is a service component responsible for managing virtual machines;
(2) Bf3-Net-Ops.py script, used to modify attributes such as queue, length and Maximum Transmission Unit (MTU) of the VF network card and send them to the virtual network port thereof;
(3) Bf3-Volume-Ops.py script, used to bind network disks with virtual devices;
(4) Snap-rpc.py script, used to view the state information of the Virtio Block VF on the smart card side;
(5) Virtnet, which is a network interface technology used in the virtualized environment, and is mainly used to create and manage virtual network interfaces in virtual machines;
(6) Storage Performance Development Kit (Spdk), which is a collection of tools and libraries designed for writing scalable user-mode storage applications with high performance;
(7) Open Virtual Switch (Ovs);
(8) Snapshot function component (Snap), used to save the state of a virtual machine at a specific point in time, including memory, magnetic disk, network configuration, etc.;
(9) Virtual Network Card Controller (Virtio Net Controller), which is a controller implemented based on the Virtio protocol;
(10) Libvirt.so dynamic library, namely, shared object library of Libvirt, which implements Libvirt's APIs so that other programs can call these APIs through dynamic linking to manage virtual machines;
(11) Libvirt Python, which is an extension library of the programming language Python, and encapsulates calling methods of some Application Programming Interfaces (APIs) related to Libvirtd; and
(12) Virtualization monitoring component (Libvirt Monitor), which can use the APIs and functions provided by the Libvirt library to implement functions such as resource allocation, performance monitoring, fault management, migration and backup of virtual machines.

Deployed on the physical machine are:
(1) Libvirtd, which is a daemon process of the virtual machine manager (Libvirt) and is responsible for managing virtual machines;
(2) Vfe Vhostd, which is a virtual machine host and a user-mode service process, used to convert Virtio Block VF and/or Virtio Net VF into Vhost User devices;
(3) Vef Vhostd Cli, which is a virtual machine control software, used to send commands to Vfe Vhostd to host the corresponding Virtio Block VF and/or Virtio Net VF to Vfe Vhostd; and
(4) Quick Emulato (Qemu), which is a widely-used open source computer emulator and virtual machine software. As a standalone hypervisor, the Qemu can run virtual machines at the application level and also supports compatible virtualization modes.

After receiving a virtual machine start command, Nova Compute may call Ovs and Virtnet through Bf3-Net-Ops.py and call Virtio Net Controller through Virtnet to prepare Virtio Net VF; and Nova Compute may also call Spdk and Snap-rpc.py through Bf3-Volume-Ops.py and call Snap through Snap-rpc.py to prepare Virtio Block VF.

After Virtio Net VF and Virtio Block VF are prepared, Nova Compute may call Libvirt Python, and Libvirt Python calls Libvirtd and then sends a device loading command to Vfe Vhostd through Vfe-cli, to host the prepared Virtio Net VF and Virtio Block VF to Vfe Vhostd. Then, Libvirtd will start Qemu to start a virtual machine, and Qemu can communicate with Vfe Vhostd.

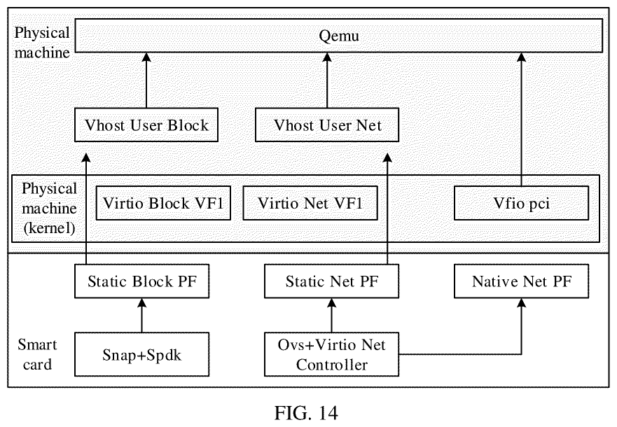

The logical architecture of the system for controlling the virtual machine will be described below in combination with FIG. 14.

Firstly, Snap+Spdk may be used to simulate a static block device, i.e., Static Block PF, through which a plurality of Virtio Block VFs may be simulated; and then, Virtio Block VF1 may be unbound from Virtio driver and then bound with Vfio driver, to be encapsulated into Vhost User Block and hosted to Vfe Vhostd; Vfe Vhostd communicates with Qemu, and Virtio Block VF may be mounted to the PCI of the physical machine. The Ovs+Virtio Net Controller may be used to simulate a static network device, i.e., Static Net PF, through which a plurality of Virtio Net VFs may be simulated; and then, Virtio Net VF1 may be unbound from Virtio driver and then bound with Vfio driver, to be encapsulated into Vhost User Net and hosted to Vfe Vhostd; Vfe Vhostd communicates with Qemu, and Virtio Net VF may be mounted to the PCI of the physical machine. The Ovs+Virtio Net Controller may be used to simulate a Native Net PF, through which a plurality of Rdma VFs (i.e., Vfio Pci) may be simulated; and then Vfio pci communicates with Qemu, and Vfio Pci may be mounted to the PCI of the physical machine.

In summary, the method for controlling the virtual machine provided in the embodiment of the present disclosure can obtain the virtual machine control request, generate the control operation instruction for the target virtual machine based on the virtual machine control request by using the Nova Compute deployed on the smart card, and then send the control operation instruction to the Libvirtd deployed on the physical machine, so as to use the Libvirtd to perform the control operation on the target virtual machine based on the control operation instruction. That is to say, in the embodiment of the present disclosure, one smart card independent of the physical machine is expanded. Based on the smart card, not only can a part of the control process for the target virtual machine be transplanted from the physical machine to the smart card, but the Snap and Ovs deployed on the smart card can also be used to provide backend resources for the target virtual machine, to reduce the virtualization overhead that the physical machine needs to bear. Therefore, the rational use of resources of the physical machine can be greatly promoted, avoiding unnecessary waste of resources.

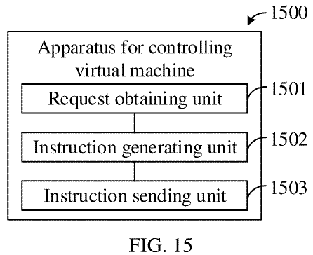

In order to better implement the above-mentioned method for controlling the virtual machine applied to the smart card included in the system for controlling the virtual machine, an embodiment of the present disclosure further provides an apparatus for controlling a virtual machine, and this apparatus may be integrated into the smart card included in the system for controlling the virtual machine. Hereinafter, the apparatus 1500 for controlling the virtual machine provided in the embodiment of the present disclosure will be described in combination with the schematic structural block diagram shown in FIG. 15.

The apparatus 1500 for controlling the virtual machine includes:
a request obtaining unit 1501 configured to obtain a virtual machine control request;
an instruction generating unit 1502 configured to generate a control operation instruction for a target virtual machine based on the virtual machine control request by using a Nova Compute deployed on the smart card; and
an instruction sending unit 1503 configured to send the control operation instruction to a Libvirtd deployed on the physical machine; where the Libvirtd is used to perform a control operation on the target virtual machine based on the control operation instruction.

In some optional implementations, the instruction generating unit 1502 is configured to:
parse the virtual machine control request to obtain control intention information for the target virtual machine; and
generate the control operation instruction for the target virtual machine based on the control intention information.

In some optional implementations, the control operation instruction includes at least one of a device mounting instruction, a device unmounting instruction, a definition instruction, a power-on instruction, a power-off instruction, a destruction instruction or a deletion instruction.

In some optional implementations, the control operation instruction includes a device mounting instruction; and the instruction generating unit 1502 is configured to:
when control intention represented by the control intention information is to mount a first virtual device on the target virtual machine, select the first virtual device from a plurality of candidate virtual devices allocated to the target virtual machine;
bind the first virtual device with a first backend resource; and
generate the device mounting instruction carrying the control intention information and a first device identifier; where the first device identifier is identification information of the first virtual device.

In some optional implementations, the instruction generating unit 1502 is configured to:
when the first virtual device is a virtual block device, use a first network disk as the first backend resource, and bind the first network disk with the first virtual device;
or, when the first virtual device is a virtual network device, use a first network port as the first backend resource, and bind the first network port with the first virtual device.

In some optional implementations, the control operation instruction includes a device unmounting instruction; and the instruction generating unit 1502 is configured to:
when control intention represented by the control intention information is to unmount a virtual device from the target virtual machine, generate the device unmounting instruction carrying the control intention information and a second device identifier; where the second device identifier is identification information of a second virtual device to be unmounted from the target virtual machine.

In some optional implementations, the apparatus 1500 for controlling the virtual machine further includes a first control unit configured to:
generate a first recycling instruction for the target virtual machine by using the Nova Compute;
delete a second backend resource bound with the second virtual device based on the first recycling instruction to release the second virtual device; and
recycle the second virtual device.

In some optional implementations, the control operation instruction includes a definition instruction; and the instruction generating unit 1502 is configured to:
when control intention represented by the control intention information is to define the target virtual machine, allocate a plurality of candidate virtual devices to the target virtual machine;
use a plurality of identification information and configuration information of the target virtual machine together as overall description information of the target virtual machine; where the plurality of identification information corresponds to the plurality of candidate virtual machines one by one; and
generate the definition instruction carrying the control intention information and the overall description information.

In some optional implementations, the control operation instruction includes a power-on instruction; and the instruction generating unit 1502 is configured to:
when control intention represented by the control intention information is to power on the target virtual machine, select a third virtual device from a plurality of candidate virtual devices allocated to the target virtual machine;
bind the third virtual device with a third backend resource;
send a redefinition instruction carrying the control intention information and overall description information to the Libvirtd; where the overall description information includes a plurality of identification information corresponding to the plurality of candidate virtual devices one by one, and configuration information of the target virtual machine; and
when receiving redefinition feedback information returned by the Libvirtd, generate the power-on instruction carrying the control intention information and a third device identifier; where the third device identifier is identification information of the third virtual device.

In some optional implementations, the instruction generating unit 1502 is configured to:
when the third virtual device is a virtual block device, use a third network disk as the third backend resource, and bind the third network disk with the third virtual device;
or, when the third virtual device is a virtual network device, use a third network port as the third backend resource, and bind the third network port with the third virtual device.

In some optional implementations, the instruction generating unit 1502 is configured to:
generate the power-on instruction carrying the control intention information, the third device identifier and port range data of the smart card.

In some optional implementations, the control operation instruction includes at least one of a power-off instruction, a destruction instruction or a deletion instruction; and the instruction generating unit 1502 is configured to:
when the control operation instruction includes the power-off instruction and control intention represented by the control intention information is to power off the target virtual machine, generate the power-off instruction carrying the control intention information;
when the control operation instruction includes the destruction instruction and control intention represented by the control intention information is to destroy the target virtual machine, generate the destruction instruction carrying the control intention information;
when the control operation instruction includes the deletion instruction and control intention represented by the control intention information is to delete the target virtual machine, generate the deletion instruction carrying the control intention information.

In some optional implementations, the apparatus 1500 for controlling the virtual machine further includes a second control unit configured to:
generate a second recycling instruction for the target virtual machine by using the Nova Compute; and
delete a fourth backend resource bound with a fourth virtual device of the target virtual machine based on the second recycling instruction to release the fourth virtual device.

In some optional implementations, the apparatus 1500 for controlling the virtual machine further includes a third control unit configured to:
obtain network disk monitoring data of the target virtual machine by using a virtualization monitoring component deployed on the smart card; and
send the network disk monitoring data to a cloud management server.

In the embodiments of the present disclosure, the specific functions and examples of the units in the apparatus 1500 for controlling the virtual machine can refer to the relevant description of the corresponding steps in the above-mentioned embodiments of the method for controlling the virtual machine, and will not be repeated here.

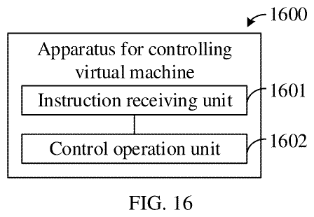

In order to better implement the above-mentioned method for controlling the virtual machine applied to the physical machine included in the system for controlling the virtual machine, an embodiment of the present disclosure further provides an apparatus for controlling a virtual machine, and this apparatus may be integrated into the physical machine included in the system for controlling the virtual machine. Hereinafter, the apparatus 1600 for controlling the virtual machine provided in the embodiment of the present disclosure will be described in combination with the schematic structural block diagram shown in FIG. 16.

The apparatus 1600 for controlling the virtual machine includes:
an instruction receiving unit 1601 configured to receive the control operation instruction; and
a control operation unit 1602 configured to perform a control operation on the target virtual machine based on the control operation instruction.

In some optional implementations, the control operation instruction includes at least one of a device mounting instruction, a device unmounting instruction, a definition instruction, a power-on instruction, a power-off instruction, a destruction instruction or a deletion instruction.

In the embodiments of the present disclosure, the specific functions and examples of the units in the apparatus 1600 for controlling the virtual machine can refer to the relevant description of the corresponding steps in the above-mentioned embodiments of the method for controlling the virtual machine, and will not be repeated here.

In the technical solution of the present disclosure, the acquisition, storage and application of the user's personal information involved are in compliance with relevant laws and regulations, and do not violate public order and good customs.

Embodiments of the present disclosure further provide an electronic device, a readable storage medium, and a computer program product.

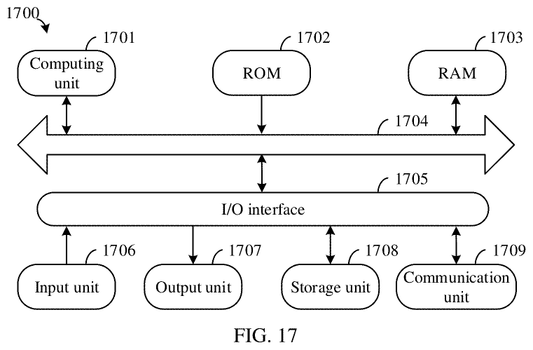

FIG. 17 shows a schematic block diagram of an exemplary electronic device 1700 that may be used to implement various examples in the embodiments of the present disclosure. The electronic device 1700 is intended to represent various forms of digital computers, such as a vehicle-mounted computing device, a laptop, a desktop, a workstation, a personal digital assistant, a server, a blade server, a mainframe computer, and other suitable computers. The electronic device 1700 may also represent various forms of mobile devices, such as a personal digital assistant, a cellular phone, a smart phone, a wearable device and other similar computing devices. The components shown herein, their connections and relationships, and their functions are merely examples, and are not intended to limit the implementation of the present disclosure described and/or required herein.

As shown in FIG. 17, the electronic device 1700 includes a computing unit 1701 that may perform various appropriate actions and processes according to a computer program stored in a Read-Only Memory (ROM) 1702 or a computer program loaded from a storage unit 1708 into a Random Access Memory (RAM) 1703. Various programs and data required for the operations of the electronic device 1700 may also be stored in the RAM 1703. The computing unit 1701, the ROM 1702 and the RAM 1703 are connected to each other through a bus 1704. The Input/Output (I/O) interface 1705 is also connected to the bus 1704.

A plurality of components in the electronic device 1700 are connected to the I/O interface 1705, and include: an input unit 1706 such as a keyboard, a mouse, or the like; an output unit 1707 such as various types of renderers, speakers, or the like; a storage unit 1708 such as a magnetic disk, an optical disk, or the like; and a communication unit 1709 such as a network card, a modem, a wireless communication transceiver, or the like. The communication unit 1709 allows the electronic device 1700 to exchange information/data with other devices through a computer network such as the Internet and/or various telecommunication networks.

The computing unit 1701 may be various general-purpose and/or special-purpose processing components with processing and computing capabilities. Some examples of the computing unit 1701 include, but are not limited to, a Central Processing Unit (CPU), a Graphics Processing Unit (GPU), various dedicated Artificial Intelligence (AI) computing chips, various computing units that run machine learning model algorithms, a Digital Signal Processor (DSP), and any appropriate processors, controllers, microcontrollers, or the like. The computing unit 1701 performs various methods and processing described above, such as the method for controlling the virtual machine. For example, in some implementations, the method for controlling the virtual machine may be implemented as a computer software program tangibly contained in a computer-readable medium, such as the storage unit 1708. In some implementations, a part or all of the computer program may be loaded and/or installed on the device 1700 via the ROM 1702 and/or the communication unit 1709. When the computer program is loaded into the RAM 1703 and executed by the computing unit 1701, one or more steps of the method for controlling the virtual machine described above may be performed. Alternatively, in other implementations, the computing unit 1701 may be configured to perform the method for controlling the virtual machine by any other suitable means (e.g., by means of firmware).

Various implementations of the system and technologies described above herein may be implemented in a digital electronic circuit system, an integrated circuit system, a Field Programmable Gate Array (FPGA), an Application Specific Integrated Circuit (ASIC), an Application Specific Standard Product (ASSP), a System On Chip (SOC), a Complex Programmable Logic Device (CPLD), a computer hardware, firmware, software, and/or a combination thereof. These various implementations may be implemented in one or more computer programs, and the one or more computer programs may be executed and/or interpreted on a programmable system including at least one programmable processor. The programmable processor may be a special-purpose or general-purpose programmable processor, may receive data and instructions from a storage system, at least one input device, and at least one output device, and transmit the data and the instructions to the storage system, the at least one input device, and the at least one output device.

The program code for implementing the method of the present disclosure may be written in any combination of one or more programming languages. The program code may be provided to a processor or controller of a general-purpose computer, a special-purpose computer or other programmable data processing devices, which enables the program code, when executed by the processor or controller, to cause the function/operation specified in the flowchart and/or block diagram to be implemented. The program code may be completely executed on a machine, partially executed on the machine, partially executed on the machine as a separate software package and partially executed on a remote machine, or completely executed on the remote machine or a server.

In the context of the present disclosure, a machine-readable medium may be a tangible medium, which may contain or store a procedure for use by or in connection with an instruction execution system, device or apparatus. The machine-readable medium may be a machine-readable signal medium or a machine-readable storage medium. The machine-readable medium may include, but is not limited to, an electronic, magnetic, optical, electromagnetic, infrared or semiconductor system, device or apparatus, or any suitable combination thereof. More specific examples of the machine-readable storage medium may include electrical connections based on one or more lines, a portable computer disk, a hard disk, an RAM, an ROM, an Erasable Programmable Read-Only Memory (EPROM) or a flash memory, an optical fiber, a portable Compact Disc Read-Only Memory (CD-ROM), an optical storage device, a magnetic storage device, or any suitable combination thereof.

In order to provide interaction with a user, the system and technologies described herein may be implemented on a computer that has: a rendering device (e.g., a Cathode Ray Tube (CRT) renderer or a Liquid Crystal Display (LCD)) for rendering information to the user; and a keyboard and a pointing device (e.g., a mouse or a trackball) through which the user may provide input to the computer. Other types of devices are also used to provide interaction with the user. For example, feedback provided to the user may be any form of sensory feedback (e.g., visual feedback, auditory feedback, or tactile feedback), and the input from the user may be received in any form (including an acoustic input, a voice input, or a tactile input).

The system and technologies described herein may be implemented in a computing system (which serves as, for example, a data server) including a back-end component, or in a computing system (which serves as, for example, an application server) including a middleware, or in a computing system including a front-end component (e.g., a user computer with a graphical user interface or web browser through which the user may interact with the implementation of the system and technologies described herein), or in a computing system including any combination of the back-end component, the middleware component, or the front-end component. The components of the system may be connected to each other through any form or kind of digital data communication (e.g., a communication network). Examples of the communication network include a Local Area Network (LAN), a Wide Area Network (WAN), and the Internet.

A computer system may include a client and a server. The client and server are generally far away from each other and usually interact with each other through a communication network. A relationship between the client and the server is generated by computer programs running on corresponding computers and having a client-server relationship with each other. The server may be a cloud server, a distributed system server, or a blockchain server.

An embodiment of the present disclosure further provides a non-transitory computer-readable storage medium storing a computer instruction thereon, and the computer instruction is used to cause a computer to execute the method for controlling the virtual machine described above.

An embodiment of the present disclosure further provides a computer program product including a computer program, and the computer program implements the method for controlling the virtual machine, when executed by a processor.

It should be understood that, the steps may be reordered, added or removed by using the various forms of the flows described above. For example, the steps recorded in the present disclosure can be performed in parallel, in sequence, or in different orders, as long as a desired result of the technical scheme disclosed in the present disclosure can be realized, which is not limited herein. Moreover, the relational terms such as “first”, “second”, “third”, etc. in this disclosure are only used to distinguish one entity or operation from another entity or operation, and do not necessarily require or imply any such actual relationship or sequence between these entities or operations. Furthermore, “a plurality of” in the present disclosure can be understood as at least two.

The foregoing specific implementations do not constitute a limitation on the protection scope of the present disclosure. Those having ordinary skill in the art should understand that, various modifications, combinations, sub-combinations and substitutions may be made according to a design requirement and other factors. Any modification, equivalent replacement, improvement or the like made within the principle of the present disclosure shall be included in the protection scope of the present disclosure.

What is claimed is:

1. A method for controlling a virtual machine applied to a smart card, the method comprising:
obtaining a virtual machine control request;
generating, based on the virtual machine control request and by using a computing node service deployed on the smart card, a control operation instruction for a target virtual machine, wherein the smart card is comprised in a system for controlling the virtual machine further comprising a physical machine; and
sending the control operation instruction to a virtualization control program deployed on the physical machine, wherein the virtualization control program is configured to perform a control operation on the target virtual machine based on the control operation instruction.

2. The method of claim 1, wherein the generating the control operation instruction comprises:
parsing the virtual machine control request to obtain control intention information for the target virtual machine; and
generating the control operation instruction for the target virtual machine based on the control intention information.

3. The method of claim 2, wherein the control operation instruction comprises at least one of a device mounting instruction, a device unmounting instruction, a definition instruction, a power-on instruction, a power-off instruction, a destruction instruction or a deletion instruction.

4. The method of claim 2, wherein the control operation instruction comprises a device mounting instruction, and the generating the control operation instruction comprises:
in a case of control intention represented by the control intention information is to mount a virtual device on the target virtual machine, selecting a first virtual device from a plurality of candidate virtual devices allocated to the target virtual machine;
binding the first virtual device with a first backend resource; and
generating the device mounting instruction comprising the control intention information and a first device identifier, wherein the first device identifier is identification information of the first virtual device.

5. The method of claim 4, wherein the binding the first virtual device with the first backend resource comprises:
in a case of the first virtual device is a virtual block device, using a first network disk as the first backend resource, and binding the first network disk with the first virtual device; or
in a case of the first virtual device is a virtual network device, using a first network port as the first backend resource, and binding the first network port with the first virtual device.

6. The method of claim 2, wherein the control operation instruction comprises a device unmounting instruction, and the generating the control operation instruction for the target virtual machine comprises:
in a case of control intention represented by the control intention information is to unmount a virtual device from the target virtual machine, generating the device unmounting instruction comprising the control intention information and a second device identifier, wherein the second device identifier is identification information of a second virtual device to be unmounted from the target virtual machine.

7. The method of claim 6, further comprising:
generating a first recycling instruction for the target virtual machine by using the computing node service;
deleting a second backend resource bound with the second virtual device based on the first recycling instruction to release the second virtual device; and
recycling the second virtual device.

8. The method of claim 2, wherein the control operation instruction comprises a definition instruction, and the generating the control operation instruction for the target virtual machine comprises:
in a case of control intention represented by the control intention information is to define the target virtual machine, allocating a plurality of candidate virtual machines to the target virtual machine;
using a plurality of identification information and configuration information of the target virtual machine together as overall description information of the target virtual machine, wherein the plurality of identification information corresponds to the plurality of candidate virtual machines one by one; and
generating the definition instruction comprising the control intention information and the overall description information.

9. The method of claim 2, wherein the control operation instruction comprises a power-on instruction, and the generating the control operation instruction for the target virtual machine comprises:
in a case of control intention represented by the control intention information is to power on the target virtual machine, selecting a third virtual device from a plurality of candidate virtual devices allocated to the target virtual machine;
binding the third virtual device with a third backend resource;
sending a redefinition instruction comprising the control intention information and overall description information to the virtualization control program, wherein the overall description information comprises a plurality of identification information corresponding to the plurality of candidate virtual devices one by one, and configuration information of the target virtual machine; and
in a case of receiving redefinition feedback information returned by the virtualization control program, generating the power-on instruction comprising the control intention information and a third device identifier, wherein the third device identifier is identification information of the third virtual device.

10. The method of claim 9, wherein the binding the third virtual device with the third backend resource comprises:
in a case of the third virtual device is a virtual block device, using a third network disk as the third backend resource, and binding the third network disk with the third virtual device; or
in a case of the third virtual device is a virtual network device, using a third network port as the third backend resource, and binding the third network port with the third virtual device.

11. The method of claim 9, wherein the generating the power-on instruction comprising the control intention information and the third device identifier comprises:
generating the power-on instruction comprising the control intention information, the third device identifier and port range data of the smart card.

12. The method of claim 2, wherein the control operation instruction comprises at least one of a power-off instruction, a destruction instruction or a deletion instruction, and the generating the control operation instruction for the target virtual machine comprises:
in a case of the control operation instruction comprises the power-off instruction and control intention represented by the control intention information is to power off the target virtual machine, generating the power-off instruction comprising the control intention information;
in a case of the control operation instruction comprises the destruction instruction and the control intention represented by the control intention information is to destroy the target virtual machine, generating the destruction instruction comprising the control intention information; and
in a case of the control operation instruction comprises the deletion instruction and the control intention represented by the control intention information is to delete the target virtual machine, generating the deletion instruction comprising the control intention information.

13. The method of claim 12, further comprising:
generating a second recycling instruction for the target virtual machine by using the computing node service; and
deleting a fourth backend resource bound with a fourth virtual device of the target virtual machine based on the second recycling instruction to release the fourth virtual device.

14. The method of claim 1, further comprising:
obtaining network disk monitoring data of the target virtual machine by using a virtualization monitoring component deployed on the smart card; and
sending the network disk monitoring data to a cloud management server.

15. A method for controlling a virtual machine applied to a physical machine, the method comprising:
receiving control operation instruction; and
performing a control operation on a target virtual machine based on the control operation instruction,
wherein the physical machine is comprised in a system for controlling the virtual machine, wherein the system for controlling the virtual machine further comprises a smart card configured to obtain a virtual machine control request and generate the control operation instruction for the target virtual machine based on the virtual machine control request and by using a computing node service deployed on the smart card.

16. The method of claim 15, wherein the control operation instruction comprises at least one of a device mounting instruction, a device unmounting instruction, a definition instruction, a power-on instruction, a power-off instruction, a destruction instruction or a deletion instruction.

17. An electronic device, comprising:
at least one processor; and
a memory connected in communication with the at least one processor;
wherein the memory stores an instruction executable by the at least one processor, and the instruction, when executed by the at least one processor, enables the at least one processor to execute the method of claim 1.

18. An electronic device, comprising:
at least one processor; and
a memory connected in communication with the at least one processor;
wherein the memory stores an instruction executable by the at least one processor, and the instruction, when executed by the at least one processor, enables the at least one processor to execute the method of claim 15.

19. A non-transitory computer-readable storage medium storing a computer instruction thereon, wherein the computer instruction is used to cause a computer to execute the method of claim 1.

20. A non-transitory computer-readable storage medium storing a computer instruction thereon, wherein the computer instruction is used to cause a computer to execute the method of claim 15.
